(19) United States
(12) Patent Application Publication
(10) Pub. No.: US 2024/0370417 A1
(43) Pub. Date: Nov. 7, 2024

(54) APPARATUS, SYSTEM AND METHOD FOR VALIDATION OF NORMALIZED IMAGE DATA WITH ALPHA-NUMERIC DATA

(71) Applicant: AMADEUS S.A.S., Biot (FR)

(72) Inventors: Ian Paton, Saint-Paul-en-Foret (FR); Samuel Griehser, Nice (FR); Florent Guerinel, Antibes (FR); Irina Hristova, Sofia (BG)

(21) Appl. No.: 18/228,984

(22) Filed: Aug. 1, 2023

Related U.S. Application Data
(60) Provisional application No. 63/463,970, filed on May 4, 2023.

(51) Int. Cl. G06F 16/215; G06F 16/11

(52) U.S. Cl. CPC G06F 16/215; G06F 16/116

(57) ABSTRACT

The present specification provides, amongst other things, a novel system, method and apparatus for comparing and validating normalized image data with alpha-numeric data. Certain embodiments have application to the process of submitting a plurality of itemized documents and compilations of those documents for assessment.

### CROSS-REFERENCE TO RELATED APPLICATION(S)

This application claims the benefit of U.S. Provisional Patent Application No. 63/463,970, filed May 4, 2023, the entire contents of which is incorporated herein by reference.

### BACKGROUND

With the advent of artificial intelligence (AI) and hardware advances, computing systems continue to automate routine human task. In one domain, optical character recognition (OCR) technology has advanced to the point of identifying, extracting and structuring alpha-numeric data within an image, with a very high degree of reliability. Artificial intelligence systems are also able to improve the quality of further OCR imaging by human training the AI-OCR engine.

Nonetheless, even with a highly trained AI-OCR engine, human input may still be required in certain applications to fulfill the automation of the human task to supplement and/or validate the output from the AI-OCR engine.

### BRIEF DESCRIPTION OF THE FIGURES

FIG. 1 is a schematic diagram of a system for validating image and alpha-numeric data.

FIG. 2 shows an example structure of the identifier objects of FIG. 1.

FIG. 3 shows a flowchart depicting a method for validating image and data.

FIG. 4 shows an example performance of certain blocks in the method of FIG. 3.

FIG. 5 shows an example performance of certain blocks in the method of FIG. 3.

FIG. 6 shows an example performance of certain blocks in the method of FIG. 3.

FIG. 7 shows an example performance of certain blocks in the method of FIG. 3.

FIG. 8 shows a flowchart depicting a method for assessing a validation risk level

FIG. 9 shows an example assessment screen that can be generated as part of the control of a device from the method of FIG. 4.

FIG. 10 shows an example assessment screen that can be generated as part of the control of a device from the method of FIG. 4.

FIG. 11 is an example of machine learning training in accordance with another embodiment.

FIG. 12 is an example of machine learning training in accordance with another embodiment.

FIG. 13 is an example of machine learning training in accordance with another embodiment.

### DETAILED DESCRIPTION

An aspect of the present specification provides a validation engine having a memory for storing programming instructions and a processor for executing the instructions; the instructions configuring the processor to:
receive one or more expense itemized compilation records in structured format;
receive at least one itemized document attachment corresponding to the expense itemized compilation records in unstructured format;
convert the at least one itemized document attachment into structured format;
correlate the at least one structured format itemized document attachment with the expense itemized compilation record into an electronic assessment report;
determine a validation risk level metric associated with each expense in the electronic assessment report; and,
control an output device based on the validation risk level metric.

The controlling can include generating, from the electronic assessment report, at least one record and an associated indicator of the risk level of the electronic assessment.

The controlling can include generating an image of the itemized document attachment corresponding to the at least one record.

The risk level indicator can include a color-code.

The risk level indicator can include a rationale message associated with the risk level.

The instructions can further comprise receiving an input representing an approval or rejection of the record.

The instructions can include updating a machine learning algorithm for a criterion applied for determining the validation risk.

The controlling can include automatically processing a transfer of electronic funds for the records below a predefined validation risk level.

The validation risk level can be based on at least one of a financial value, a type of itemized document attachment, a type of expense, a duplication of a itemized document attachment, and a type of origin category.

The validation risk level can be based on a comparison of duplication between sets of itemized compilation records such as expense statement records.

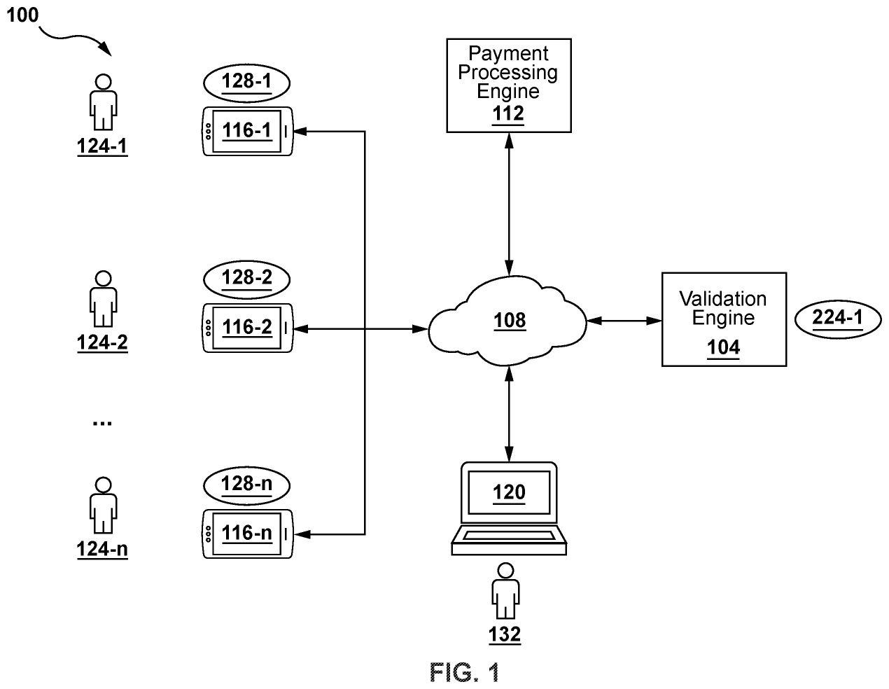

FIG. 1 shows a system for validating image and alpha-numeric data indicated generally at 100. System 100 comprises a validation engine 104. In system 100, engine 104 connects to a network 108 such as the Internet. Network 108 interconnects validation engine 104 with: a) a payment processing engine 112; b) a plurality of client devices 116; and, d) an administrator workstation 120. As will be discussed further below, validation engine 104 performs a number of processing functions for system 100.

(Note that, collectively, client devices 116-1, 116-2 . . . 116-n are referred to as devices 116, and generically, as device 116. This nomenclature is used elsewhere herein.)

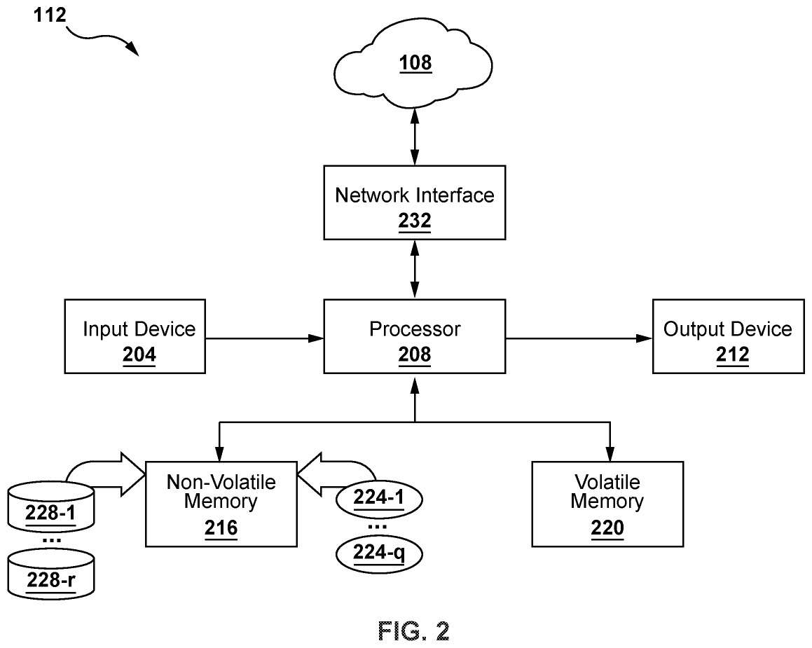

FIG. 2 shows a schematic diagram of a non-limiting example of internal components of validation engine 104. In this example, validation engine 104 includes at least one input device 204. Input from device 204 is received at a processor 208 which in turn controls an output device 212. Input device 204 can be a traditional keyboard and/or mouse to provide physical input. Likewise output device 212 can be a display. In variants, additional and/or other input devices 204 or output devices 212 are contemplated or may be omitted altogether as the context requires.

Processor 208 may be implemented as a plurality of processors or one or more multi-core processors. The processor 208 may be configured to execute different programing instructions responsive to the input received via the one or more input devices 204 and to control one or more output devices 212 to generate output on those devices.

To fulfill its programming functions, the processor 208 is configured to communicate with one or more memory units, including non-volatile memory 216 and volatile memory 220. Non-volatile memory 216 can be based on any persistent memory technology, such as an Erasable Electronic Programmable Read Only Memory (“EEPROM”), flash memory, solid-state hard disk (SSD), other type of hard-disk, or combinations of them. Non-volatile memory 216 may also be described as a non-transitory computer readable media. Also, more than one type of non-volatile memory 216 may be provided.

Volatile memory 220 is based on any random access memory (RAM) technology. For example, volatile memory 220 can be based on a Double Data Rate (DDR) Synchronous Dynamic Random-Access Memory (SDRAM). Other types of volatile memory 220 are contemplated.

Processor 208 also connects to network 108 via a network interface 232. Network interface 232 can also be used to connect another computing device that has an input and output device, thereby obviating the need for input device 204 and/or output device 212 altogether.

Programming instructions in the form of applications 224 are typically maintained, persistently, in non-volatile memory 216 and used by the processor 208 which reads from and writes to volatile memory 220 during the execution of applications 224. Various methods discussed herein can be coded as one or more applications 224. One or more tables or databases 228 are maintained in non-volatile memory 216 for use by applications 224.

The infrastructure of validation engine 104, or a variant thereon, can be used to implement any of the computing nodes in system 100, including payment processing engine 112. Furthermore, validation engine 104 and payment processing engine 112 may also be implemented as virtual machines and/or with mirror images to provide load balancing.

Furthermore, a person of skill in the art will recognize that the core elements of processor 208, input device 204, output device 212, non-volatile memory 216, volatile memory 220 and network interface 232, as described in relation to the server environment of validation engine 104, have analogues in the different form factors of client machines such as those that can be used to implement client devices 116 and workstation 120. Client devices 116 and workstation 120 can be based on any combination of computer workstations, laptop computers, tablet computers, mobile telephony devices or the like.

Each device 116 and its user 124 is thus associated with a user identifier object 128. A person of skill in the art is to recognize that the form of an identifier object 128 is not particularly limited, and in a simple example embodiment, can simply be an alpha-numerical sequence that is entirely unique in relation to other identifier objects in system 100. Identifier objects can also be more complex as they may be combinations of account credentials (e.g. user name, password, Two-factor authentication token, etc.) that uniquely identify a given user 124. Identifier objects themselves may also be indexes that point to other identifier objects, such as accounts. The salient point is that they are uniquely identifiable within system 100 in association with what they represent. The user identifier object 128 can thus be used as part of authenticating an account and/or session with validation engine 104 and/or payment processing engine 112.

According to the present embodiment, client devices 116 are based on any suitable client computing platform operated by users 124 for submitting expense claims to submit for reimbursement by their employer or other entity. Expense claims very commonly include reimbursement for travel, such as transportation, accommodation and meals. Expense claims may also include small equipment purchases or the like. The nature of the expense claim itself is not particularly limited and is provided for illustrative purposes, though not necessarily relevant to the technical aspects of this specification.

As will be discussed in greater detail below, validation engine 104 hosts an expense reimbursement application 224-1. Application 224-1 enables an expense reimbursement process that includes a user 124 logging into an account hosted by engine 104 via credentials associated with their respective identifier object 128. The user 124 can then interact with graphical interfaces generated by engine 104 on the display of a respective device 116 to receive detailed alpha-numeric information articulating the particulars of the expense claim, and also to upload images of itemized documents such as receipts or other documentation that support the alpha-numeric information. In due course, the expense claim will be approved (or denied), in whole or in part, by engine 104, either automatically or with human oversight manifested at workstation 120 by an administrator 132. Payment for the approved portions of the claim can be effected by payment processing engine 112 which oversees the transfer of funds to a financial account associated with the respective user.

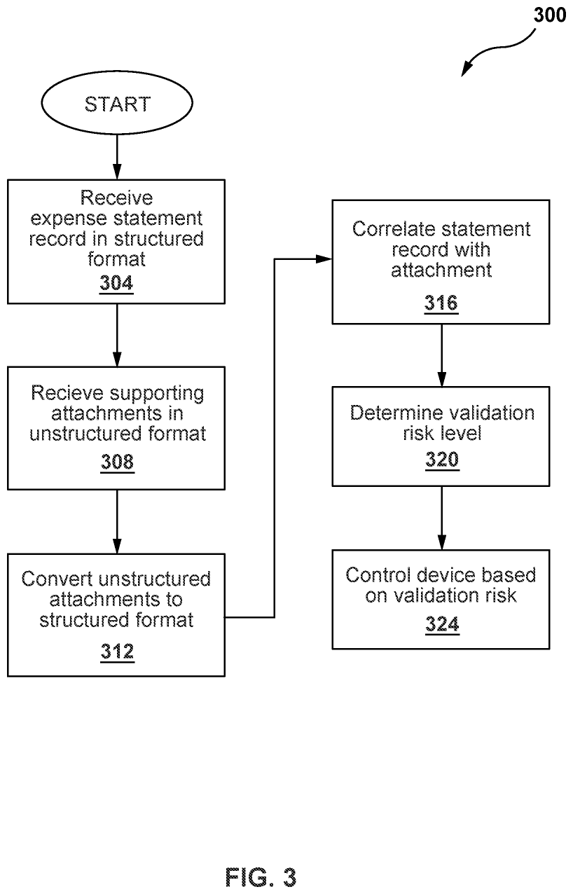

To elaborate, FIG. 3 shows a flowchart depicting a method for validating image and alpha-numeric data indicated generally at 300. Method 300 can be implemented on system 100. Persons skilled in the art may choose to implement method 300 on system 100 or variants thereon, or with certain blocks omitted, performed in parallel or in a different order than shown. Method 300 can thus also be varied. However, for purposes of explanation, method 300 will be described in relation to its performance on system 100 with a specific focus on treating method 300 as, for example, a portion of expense reimbursement application 224-1 maintained within validation engine 104 and its interactions with the other nodes in system 100.

Block 304 comprises receiving one or more expense itemized compilation records in a structured format. Generally, block 304 comprises providing a data entry screen on device 116 with various alphanumeric text fields that can receive data via keyboard or touch screen that particularize, in structured format, a particular item for an expense claim. Block 308 comprises receiving one or more supporting attachments in an unstructured format. Generally, block 308 comprises providing a means to upload an image, perhaps by a camera on device 116 or by accessing the file storage on device 116 that already includes the image. The image will typically be a copy of a physical itemized document for the expenses articulated at block 304.

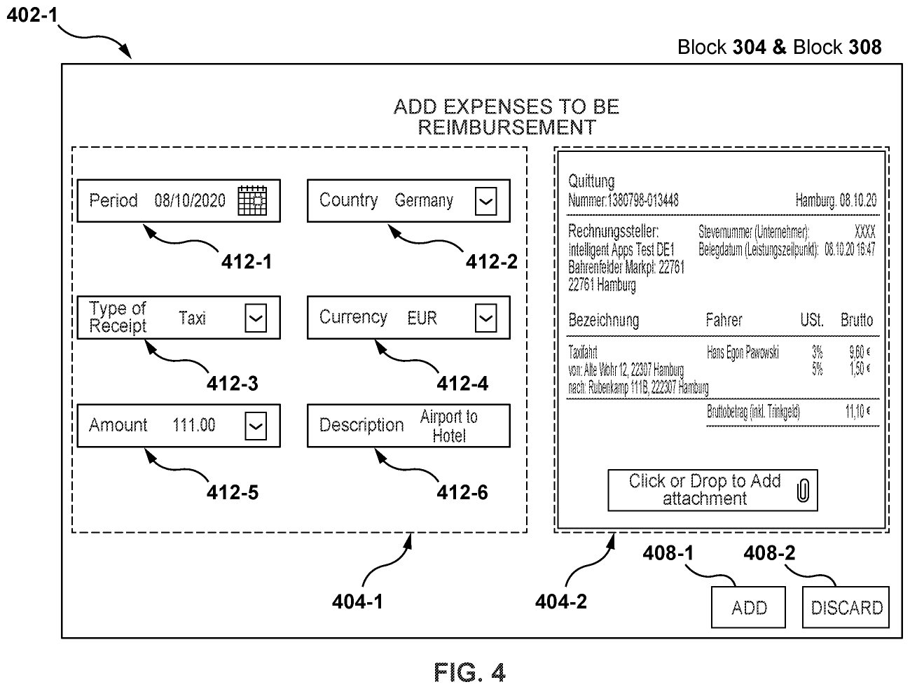

FIG. 4 shows a non-limiting example of a data entry screen in the form of a graphical interface 402-1 that can be generated on a device 116. Interface 402-1 can be used to enter an expense itemized compilation record and thereby implement block 304 and block 308, and reused for a plurality of different expense itemized compilation records. Again, FIG. 4 is simply one example and a person of skill in the art will appreciate the multitude of ways block 304 and block 308 can be implemented.

In FIG. 4 interface 402-1 includes two regions 404, which are indicated for labelling purposes by a dashed outline that does not form part of the actual interface 402-1. Region 404-1 represents various fields that can be used to input structured data respective to block 304. Note that in the present example, region 404-1 includes a period data field 412-1 (with example contents “Aug. 10, 2020”), a country data field 412-2 (with example contents “Germany”), a type-of-itemized document data field 412-3 (with example contents “Taxi”), a currency data field 412-4 (with example contents “EUR”), an amount data field 412-5 (with example contents “111.00”), and a description data field 412-6 (with example contents “Airport to Hotel”). These are merely example fields and more or fewer fields can be provided according to the expense reimbursement system policy that is desired to be implemented.

Also note that region 404-2 represents an attachment dialogue box that can be used to input unstructured data, which can be “clicked” or selected to either activate a camera function on device 116, or to access storage locations available to device 116, or to allow an image file, such as a itemized document, to be “dragged and dropped” into region 404-2. The image file thus contains unstructured data that supports the expense reimbursement referenced in region 404-1. The data provided in each region 404 thus corresponds to the same expense item or expense record.

Control buttons 408 are also included on interface 402-1 to provide overall instructions regarding the data in each region 404. Additional control buttons 408 could be added such as “Save” or “Edit” or “Duplicate”, as desired.

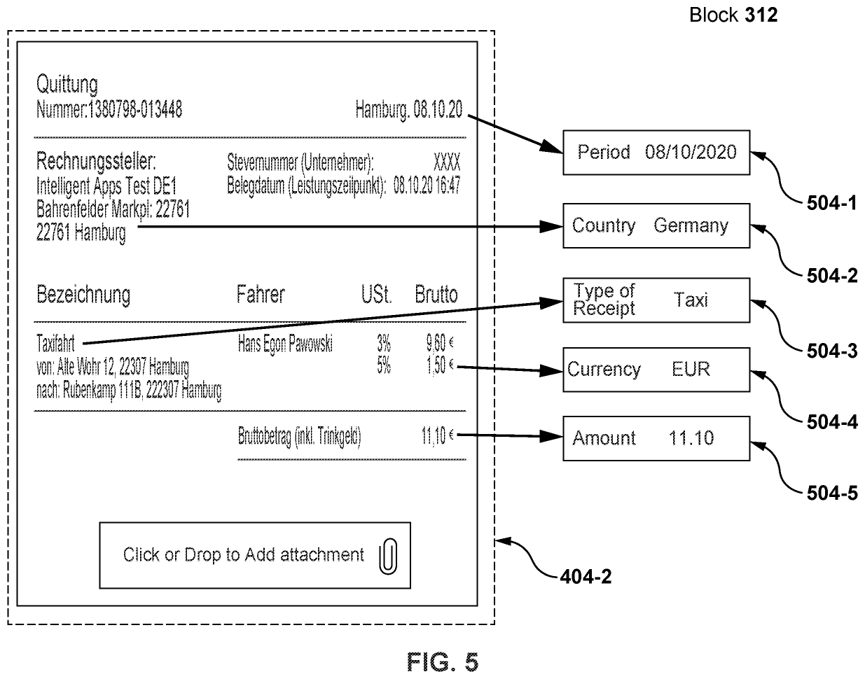

Referring again to FIG. 3, block 312 comprises converting the unstructured formatted data received at block 308 into structured data. Block 312 can be performed by an optical character recognition (OCR) system that may or may not be combined with artificial intelligence (AI) training in order to increase accuracy. The function may be performed locally on validation engine 104 or via a cloud service located (not shown) on network 108. Example performance of block 312 is shown in FIG. 5 as a various data are extracted and stored in various data fields 504 corresponding to a time period data field 504-1 (with example contents “Aug. 10, 2020”), a country data field 504-2 (with example contents “Germany”), a type of itemized document data field 504-3 (with example contents “Taxi”), a currency data field 504-4 (with example contents “EUR”) and an amount data field 504-5 (with example contents “11.10”).

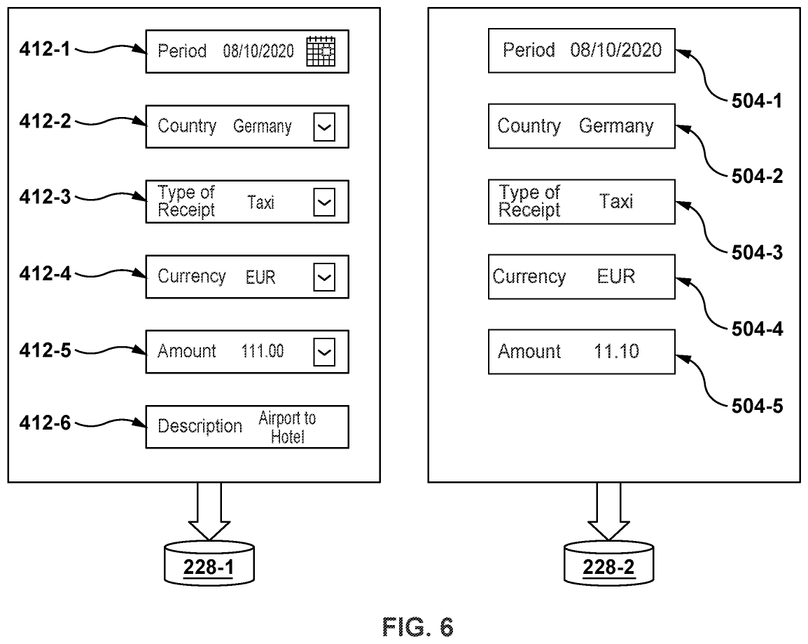

As shown in FIG. 6, structured data fields 412 received in region 404-1 at block 304 are thus stored in dataset 228-1 of nonvolatile memory 216, and the structured data fields 504 from block 312 are thus stored in dataset 228-2 of nonvolatile memory 216 of engine 104.

Returning to FIG. 3, block 316 comprises correlating the one or more itemized compilation records from block 304 with the corresponding supporting attachments as converted into structured format at block 312. In general terms, block 316 comprises performing a comparison between fields 412 and their respective fields 504 for alignment. Generally, it would be expected that the structured data from block 308 would match the structured data generated at block 312. Block 316 compares fields 412 with fields 504 to identify matches and/or anomalies.

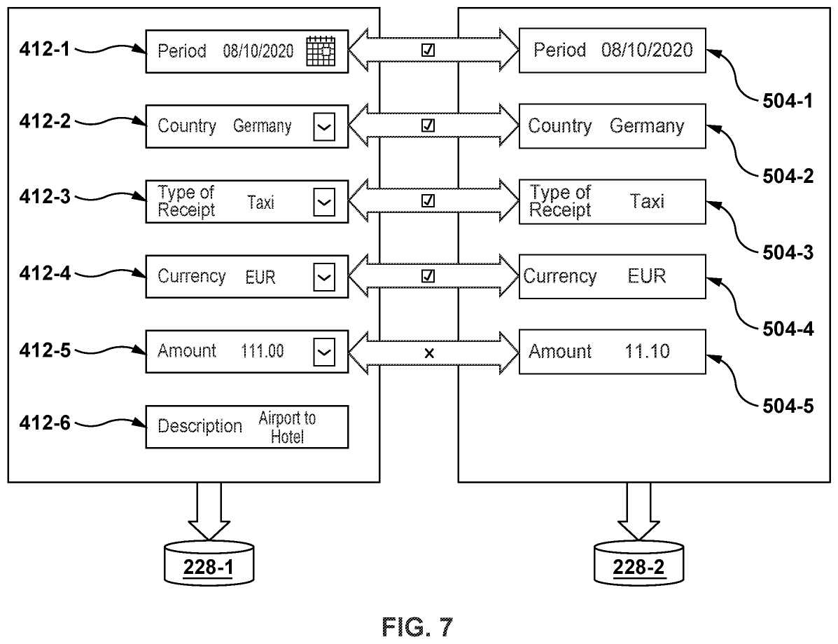

FIG. 7 represents performance of block 316 by processor 208 upon dataset 228-1 and dataset 228-2 according to the previous example from FIG. 6. Note that field 412-6 is omitted from the comparison as it is subjective to the user 124 and cannot be inferred from the attachment. Also note that in FIG. 7, field 412-1 and field 504-1 are found to match; field 412-2 and field 504-2 are found to match; field 412-3 and field 504-3 are found to match; and field 412-4 and field 504-4 are found to match. However, as part of performance of block 316 it is noted that field 412-5 contains the amount “111.00”, while field 504-4 contains the amount “11.10” and thus a discrepancy is noted. Subjectively, it appears that a data entry error was made when inputting the amount of the taxi into field 412-5, and objectively, one can ascertain that the error was by a multiplication factor of ten.

A person of skill in the art will now recognize that block 316 comprises validating all of the structured data from block 304 with the supporting unstructured data from block 308. In a trivial example, where block 316 results in proper matches between all fields, then validation engine 104 (or another component in system 100) can control payment processing engine 112 to fulfill payment of the expense claim back to a financial account of the appropriate user 124. However, system 100 is provided precisely to provide an electronically automated assessment system to audit and/or detect the very sorts of errors founds between the example where field 412-5 contains the amount “111.00” while field 504-4 contains the amount “11.10”, which could lead an over-reimbursement of nearly one-hundred Euros.

Several exception-handling workflow options for system 100 are possible at this point, including automatically returning the expense record claim back to the relevant device 116 for correction and/or deletion by user 124. Another possible exception-handling is to divert the expense record claim to workstation 120 where an administrator 132 can manually review the discrepancy and/or correct it and/or reject the claim and/or return the claim to the device 116 and user. While these exception-handling protocols are not expressly shown in FIG. 3, they are nonetheless contemplated within the scope of the present specification.

However, not all discrepancies may be worth flagging for exception handling, in the sense that system 100 may be configured to have an acceptable error rate such that overall utilization of computing and communication resources in system 100 is still more efficiently utilized than simply grinding the expense reimbursement process to a complete halt or immediately slowing it down through the aforementioned exception-handling protocols. Accordingly, referring again to FIG. 3, method 300 includes block 320 which comprises determining a validation risk level based on the correlations from block 316. A complete set of matches at block 316 can lead to a determination of a “zero” risk level at block 320, but anything other than a “zero” risk level may, or may not, invoke exception-handling protocols including the above examples.

Block 316 will be explained further below, but for now note that method 300 advances from block 320 to block 324 where a device is controlled based on the validation risk from block 316. The device in block 324 can be an output device on engine 104 and/or another node in system 100, and again. Block 324 can also implement any exception-handling protocol including the ones indicated above. Regardless of the way in which the device from block 324 is controlled, upon completion of block 324 method 300 ends or starts anew.

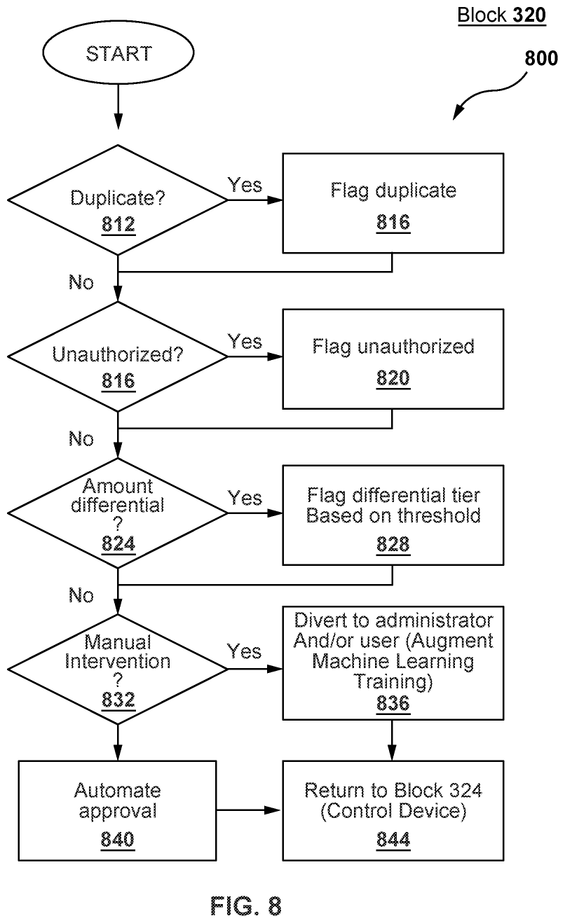

To elaborate, FIG. 8 shows a flowchart depicting a method for determining a validation risk level indicated generally at 800. Method 800 can be one way of implementing block 320. Method 800 can be implemented on system 100. Persons skilled in the art may choose to implement method 800 on system 100 or variants thereon, or with certain blocks omitted, performed in parallel or in a different order than shown. Method 800 can thus also be varied. However, for purposes of explanation, method 800 will be described in relation to its performance on system 100 with a specific focus on treating method 800 as an implementation of block 320 as, for example, a portion of expense reimbursement application 224-1 maintained within validation engine 104 and its interactions with the other nodes in system 100.

Block 812 comprises determining if the expense record from block 304 is a duplicate. Block 812 can include determining if an identical expense record has already been created. Block 812 can also include correlating the supporting attachment from block 308 to determine if the same supporting attachment was previously submitted by the same user 124, or by an accompanying user 124, in which case the expense would be flagged as a duplicate at block 816 as disallowable or other further handling, such as by determining if the accompanying users 124 had “split” payment of the expense. But to give a simple example, if two users 124 shared the same taxi, it is a potential risk that both users 124 might submit the expense related to the taxi for reimbursement.

Block 816 comprises determining if the expense record from block 304 was authorized. Block 816 can be based on a potential to deny a portion or the entirety of the expense. The entirety of the expense may be denied if the itemized document was for a single package of cigarettes, assuming the relevant travel policy denied expense reimbursement for cigarettes. A portion of the expense may be denied if the itemized document was found to include certain authorized expenses (such as a hotel room) but also included certain unauthorized expenses (such as a spa treatment at the hotel). An identification of an expense, in part or entirely, may be flagged as such at block 820.

Block 824 comprises determining if a difference in amount has occurred. A complete match between amounts can lead to a “no” condition with no flags raised. A salient example of a “yes” condition being reached at block 824 can be found in FIG. 7, where an entered expense amount was for 111.00 Euros, while the supporting itemized document was found to be only for 11.10 Euros. In this event, at block 828, where the differential was for nearly one-hundred Euros, a “high” differential tier can be assigned. However, if the financial differential was less than a given threshold, such as, for example, less than five Euros, then a “low” differential tier can be assigned. The thresholds for various flags at block 828 can be customized. In addition to flagging, block 828 can also comprise an automated adjustment or correction of the amount, such as in the current example by adjusting the amount in field 412-5 to read “11.10 Euros” to conform with field 504-5.

Block 832 comprises determining if a manual intervention is required or otherwise desirable. The criteria at block 832 can be adjusted or customized as desired. For example, a series of “no” determinations at the previous determination blocks in method 800 can lead a “No” determination at block 832 and result in automated approval of the expense report at block 840, which in turn can lead back to block 324 and the control of payment processing engine 112 to fulfill reimbursement for the relevant user 124 via their financial services account associated directly or indirectly with their account associated with their respective object 128.

By the same token, even certain “yes” determinations at the prior determination blocks of method 800 can still result in a “no” determination at block 832 and lead to automated approval at block 840. For example, if the differential was below a certain threshold at block 824, validation engine 104 can still be configured to simply accept the differential and give the user 124 the “benefit of the doubt”. Alternatively, engine 104 may automatically correct the amount, proceed with payment processing and send a report to the user 124 inviting the user 124 to review the automated decision.

In general, machine learning, neural networks or other artificial intelligence techniques may be employed at block 832, with various manual interventions at block 836 being successively used to train a machine learning model as to which combinations of “Yes” determinations at the determination block of method 800, and which thresholds at block 828, may still lead to an automated approval at block 840 or result in a diversion to an administrator or user at block 836.

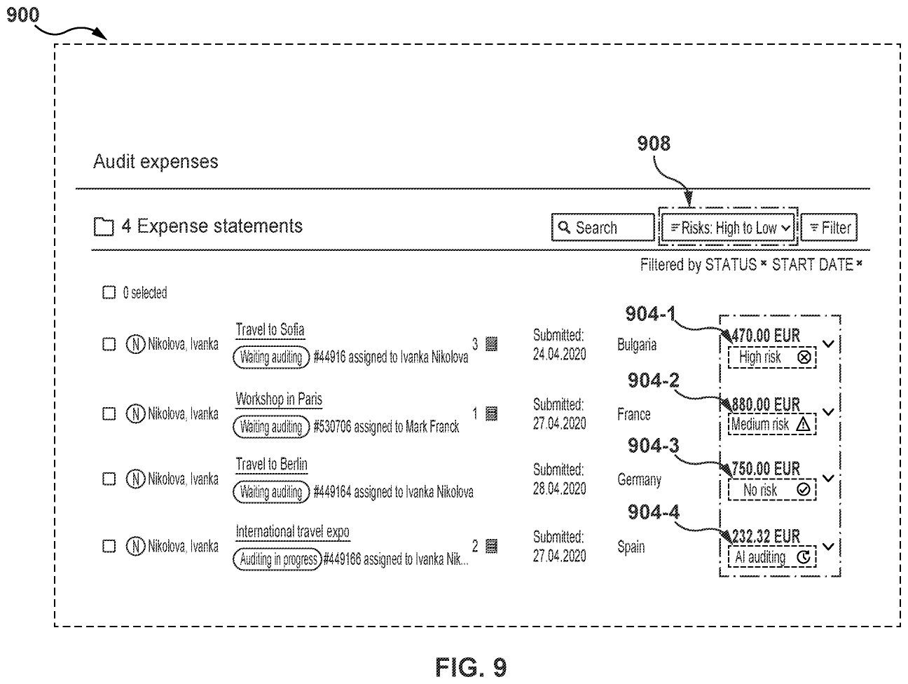

Referring now to FIG. 9, another example graphical interface is indicated generally at 900. Interface 900 is another embodiment of the present specification. Interface 900, and/or variants thereon, can be generated on workstation 120 for an administrator 132 and/or on a device 116 respective to a user 124 who entered the expense at the beginning of method 300. Interface 900 can reproduce various processed expense itemized compilations by method 300 and be generated as part of block 836. Interface 900 notably includes a plurality of status icons 904 that can arise out of performance of method 800. Selector button 908 can be used to sort status icons 904 in order of risk from low to high or high to low, as ascertained during the decision blocks of method 800. Icon 904-1 indicates a determination of “High Risk”; Icon 904-2 indicates a determination of “Medium Risk”; Icon 904-3 indicates a determination of “No Risk”; Icon 904-4 indicates “Al assessment” or “Wait for processing”, indicating that method 800 (or its variant) is still executing. Icons 904 provide administrator 132 (or other user 124) a rapid means to determine whether additional correction and/or assessment of a given expense is required. Notably, system 100 can be configured to automatically process (block 840) an expense associated with icon 904-3, but to require further intervention for an expense associated with icon 904-1. As an interesting example, however, system 100 may be configured to either automatically proceed with a “medium risk” expense entry associated with icon 904-2 or require further manual assessment. The machine learning algorithm can be configured to monitor how the further manual assessment resolves for assessments for either icon 904-1 or icon 904-2 and over time adjust the assignment of the relevant icon 904 during further iterations of method 300 and method 800.

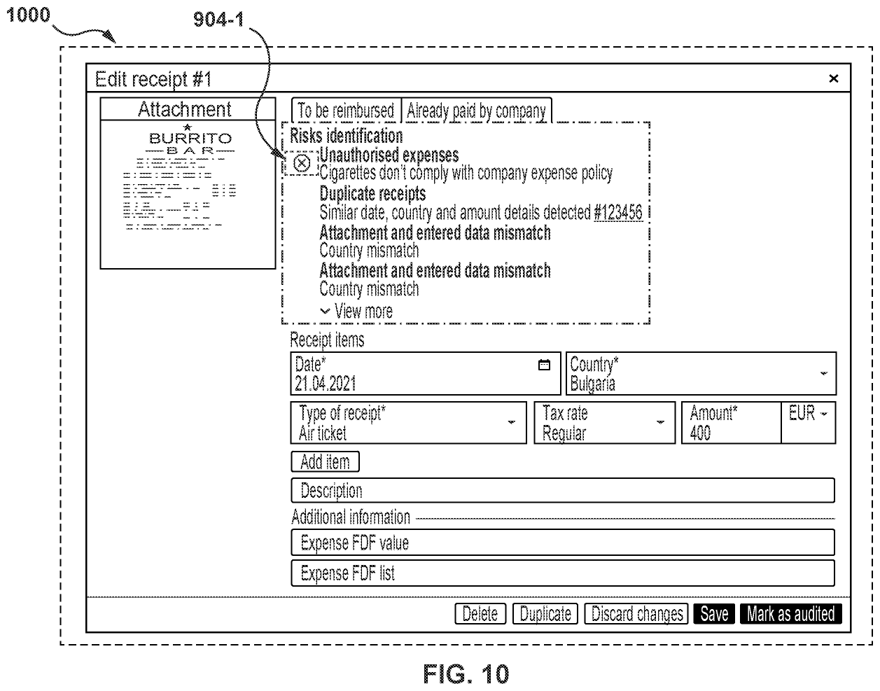

Referring now to FIG. 10, another example graphical interface is indicated generally at 1000. Interface 1000 is another embodiment of the present specification. Interface 1000, and/or variants thereon, can be generated on workstation 120 for an administrator 132 but are typically generated on a device 116 respective to a user 124 who entered the expense at the beginning of method 300. Of note is that “High Risk” icon 904-1 is included on interface 1000. Interface 1000 can thus be a result of block 836 and block 324, to cause a given expense record to be “returned” to the user 124 for further editing and review given that the expense record exceeded a validation risk level from block 320. Several risks were identified including the fact that the type of expense was not authorized, that the itemized document was a duplicate of another itemized document, and that the currency indicator did not match, and that the country did not match. The example on interface 1000 is extreme and indicates the activation of several “yes” determination in method 800. Interface 1000 invites the user 124 to edit or delete the expense claim, essentially returning the user 124 to block 304 and block 308 for further processing by the user 124. Notably, the machine learning algorithm associated with method 300 and method 800 can also learn from the responses of the user 124 into interface 1000 for future automation.

In view of the above it will now be apparent that variants, combinations, and subsets of the foregoing embodiments are contemplated. For example, validation engine 104 may be obviated or its function distributed throughout a variant on system 100, such that method 400 can occur inside a validation engine 104 during a session with a client device 116, with data from block 408 being locally generated inside the engine 104 with appropriate communications with a booking engine 112 in order to generate and receive the travel itinerary at block 412.

Accordingly, in this variant, one or more of the applications 224 may include machine learning or artificial intelligence with any desired related machine learning deep-learning based algorithms and/or neural networks, and the like, which are trained to improve the machine learning functions at block 836 and block 844. The machine learning applications 224 may be operated by the processor 208 in a training mode to train the machine learning and/or deep-learning based algorithms and/or neural networks of the machine learning applications 224 in accordance with the teachings herein.

The one or more machine-learning algorithms and/or deep learning algorithms and/or neural networks of the machine learning applications 224 may include, but are not limited to: a generalized linear regression algorithm; a random forest algorithm; a support vector machine algorithm; a gradient boosting regression algorithm; a decision tree algorithm; a generalized additive model; neural network algorithms; deep learning algorithms; evolutionary programming algorithms; Bayesian inference algorithms; reinforcement learning algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like.

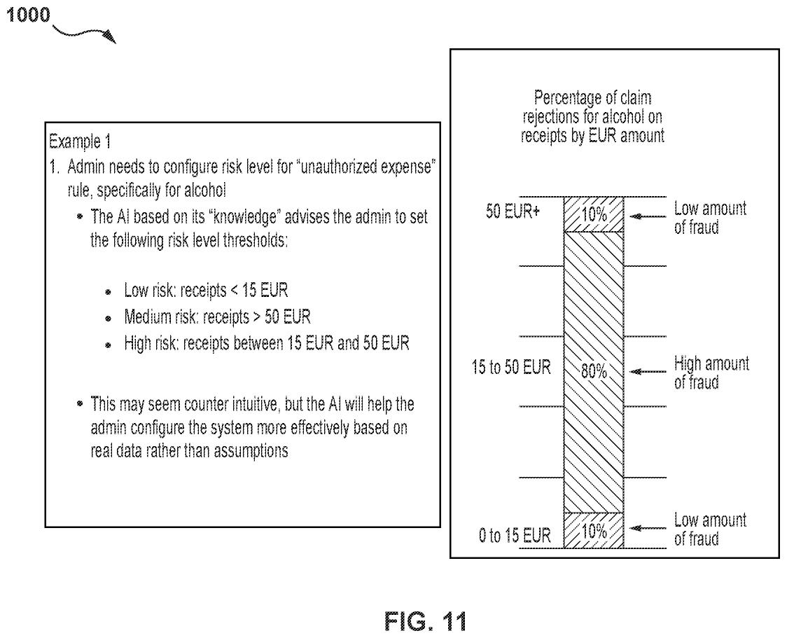

The machine learning algorithms can be specifically configured to certain purchase types. A first example is shown in FIG. 11. In this example, alcohol purchase may be flagged with different thresholds, with the machine learning algorithm learning from previous approvals and denials of a large dataset of prior manual expense claim submissions. Certain historical analyses have led to the discovery that various thresholds may be counterintuitive, such as in the example of alcohol, where there is seen to be a low likelihood of fraud below a de minimus numbers, such as 15 Euros; and a low amount of risk above a certain threshold, such as 50 Euros, but a higher amount of risk between 15 Euros and 50 Euros. These risk assignments may seem counterintuitive because interestingly a high level of fraud does not tend to occur when alcohol expenses exceed a certain threshold. A machine learning algorithm can thus assist administrators with automatic validations, or by providing assistive evaluations where likelihood levels of fraud are flagged in a message screen to the administrator, but the administrator makes the final determination. The administrator's final decision can then in turn feed back into the machine learning algorithm.

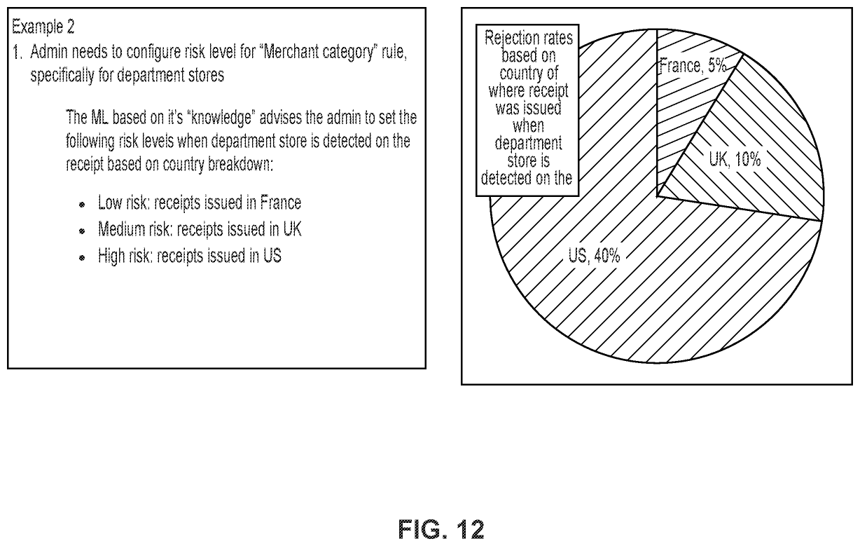

The machine learning algorithms can be specifically configured for certain purchase locations or types of vendors or origin categories. A second example is shown in FIG. 12. In this example, “department store” origin category may be flagged with different thresholds of risk, depending on the geographic location. According to this example, in certain countries travellers may be more likely to purchase business-travel meals at department stores than in other countries. The machine learning algorithm can learn from previous approvals and denials of a large dataset of prior manual expense claim submissions. Again, certain historical analyses have led to the discovery that various thresholds may be counterintuitive, such as in the example of department store origin category, where meals allegedly purchased from department stores are typically low risk from France, medium risk from the UK, and high risk from the USA. A machine learning algorithm can thus assist administrators with automatic validations, or by providing assistive evaluations where likelihood levels of fraud are flagged in a message screen to the administrator, but the administrator makes the final determination. The administrator's final decision can then in turn feed back into the machine learning algorithm.

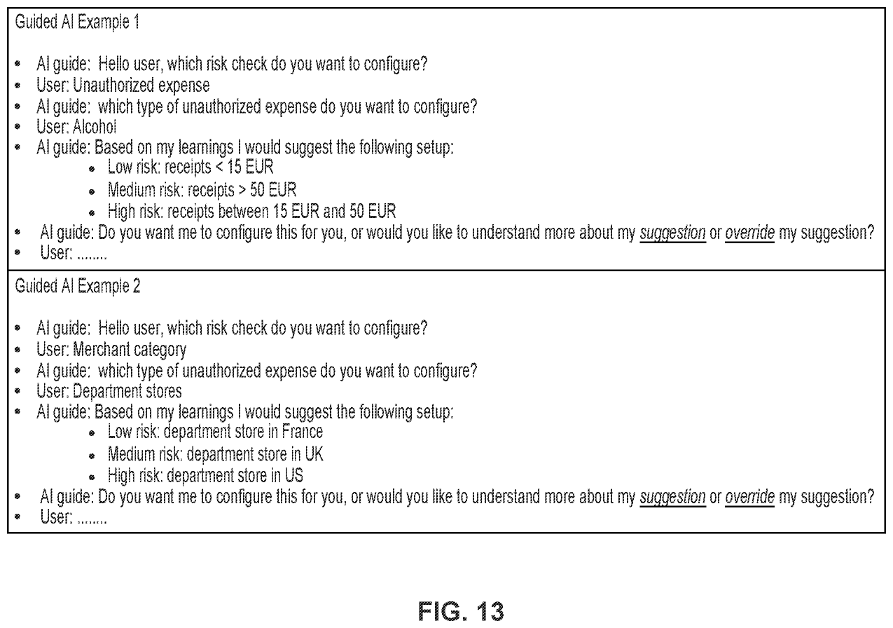

The examples in FIG. 11 and FIG. 12 may also be implemented with the use of a chatbot, such as a large language model chatbot like ChatGPT, to provide natural language interactions with the administrator in order to help the administrator make certain classifications. An example of natural language chatting consistent with the examples of FIG. 11 and FIG. 12, is shown in FIG. 13.

In a still further example, building on the example in FIG. 13, the chatbot, especially when implemented using a large language model can also receive queries from the administrator (or “user” in the Figures). The queries can say something like: “Based on this alcohol receipt, can you examine the prior examples of whether this receipt is likely to be classified as fraudulent”. This then sets the machine learning application to parse the current itemized receipt and compare it to a large aggregated dataset of prior itemized receipts and approvals. The administrator can view responses and still make a subjective final determination as to whether to allow the expense, or not, and the determination itself can go into updating the machine learning training model.

A person skilled in the art will now appreciate that the teachings herein can improve the technological efficiency and computational and communication resource utilization across system 100 by applying a validation risk level to itemized documents such as receipts during assessments and audits, optionally coupled with machine learning, and generating that risk level for an administrator or the user in a dashboard or icon form. In this fashion, anomalies in expense reports may be more automatically handled to reduce the system resources required to send the reports back and forth between user and administrator by increasing the throughput of automated expense reimbursements while also providing a graphical interface that makes machine learning amenable.

It should be recognized that features and aspects of the various examples provided above can be combined into further examples that also fall within the scope of the present disclosure. In addition, the figures are not to scale and may have size and shape exaggerated for illustrative purposes.

1. A validation engine having a memory for storing programming instructions and a processor for executing the instructions; the instructions configuring the processor to:
receive one or more itemized compilation records in structured format; receive at least one itemized document attachment corresponding to the itemized compilation records in unstructured format;
convert the at least one unstructured format itemized document attachment into structured format;
correlate the at least one structured format itemized document attachment with the itemized compilation record into an electronic assessment report;
determine a validation risk level metric associated with each item in the electronic assessment report;
automatically approve or correct the electronic assessment report based on the validation risk level metric being below a predefined threshold and,
control an output device based on the validation risk level metric.

2. The validation engine of claim 1 wherein the controlling includes generating, from the electronic assessment report, at least one record and an associated indicator of the risk level of the electronic assessment.

3. The validation engine of claim 2 wherein the controlling includes generating an image of the itemized document attachment corresponding to the at least one record.

4. The validation engine of claim 2 wherein the risk level indicator includes a color-code.

5. The validation engine of claim 2 wherein the risk level indicator includes a message associated with the risk level.

6. The validation engine of claim 2 wherein the instructions further comprise receiving an input representing an approval or rejection of the record.

7. The validation engine of claim 6 further comprising the instruction of updating a machine learning algorithm for a criterion applied for determining the validation risk.

8. The validation engine of claim 1 wherein the controlling includes automatically processing a transfer of electronic funds for the records below the predefined threshold.

9. The validation engine of claim 1 wherein the validation risk level is based on at least one of a financial value, a type of itemized document attachment, a type of item, a duplication of an itemized document attachment, and a type of origin category.

10. The validation engine of claim 1 wherein the validation risk level is based on a comparison of duplication between sets of itemized compilation records.

11. A computer implemented method for validation of normalized image data with alpha-numeric data comprising:
receiving one or more itemized compilation records in structured format;
receiving at least one itemized document attachment corresponding to the itemized compilation records in unstructured format;
converting the at least one unstructured format itemized document attachment into structured format;
correlating the at least one structured format itemized document attachments with the one or more itemized compilation records into an electronic assessment report;
determining a validation risk level metric associated with each item in the electronic assessment report;
automatically approving or correcting the electronic assessment report based on the validation risk level metric being below a predefined threshold and,
controlling an output device based on the validation risk level metric.

12. The method of claim 11 wherein the controlling includes generating, from the electronic assessment report, at least one record and an associated indicator of the risk level of the electronic assessment.

13. The method of claim 12 wherein the controlling includes generating an image of the itemized document attachment corresponding to the at least one record.

14. The method of claim 12 wherein the risk level indicator includes a color-code.

15. The method of claim 12 wherein the risk level indicator includes a message associated with the risk level.

16. The method of claim 12 further comprising receiving an input representing an approval or rejection of the record.

17. The method of claim 16 further comprising the instruction of updating a machine learning algorithm for a criterion applied for determining the validation risk.

18. The method of claim 11 wherein the controlling includes automatically processing a transfer of electronic funds for the records below the predefined threshold.

19. The method of claim 11 wherein the validation risk level is based on at least one of a financial value, a type of itemized document attachment, a type of item, a duplication of an itemized document attachment, and a type of origin category.

20. The method of claim 11 wherein the validation risk level is based on a comparison of duplication between sets of itemized compilation records.
